(19) United States
(12) Patent Application Publication
(10) Pub. No.: US 2007/0052419 A1
(43) Pub. Date: Mar. 8, 2007

(54) Mri system with variable field of view magnet

(76) Inventor: Johannes Overweg, Uelzen (DE)

Correspondence Address: PHILIPS INTELLECTUAL PROPERTY & STANDARDS, 595 MINER ROAD, CLEVELAND, OH, 44143, US

(21) Appl. No.: 10/595,581

(22) PCT Filed: Oct. 6, 2004
(86) PCT No.: PCT/IB04/52004

§ 371 Date: Apr. 28, 2006

Related U.S. Application Data
(60) Provisional application No. 60/515,614, filed on Oct. 30, 2003.

(51) Int. Cl. G01V 3/00

(52) U.S. Cl. 324/318

(57) ABSTRACT

A magnetic resonance imaging apparatus includes a first magnetic field coil (30) and a second magnetic field coil (32). A power supply (40, 42) energizes the first magnetic field coil (30) and selectively energizes the second magnetic field coil (32) to selectively generate a first magnetic field defining a first selectable field of view (FOV1) that is elongated in a first direction and a second magnetic field defining a second selectable field of view (FOV2) that is elongated in a second direction different from the first direction.

The following relates to the magnetic resonance arts. It finds particular application in short-bore magnetic resonance imaging scanners, and will be described with particular reference thereto. However, it also finds application in long-bore and other types of magnetic resonance imaging scanners, in magnetic resonance spectroscopy, and in other magnetic resonance applications.

Magnetic resonance imaging scanners with short magnet bores, such as magnet bores shorter than one meter, are of interest for alleviating patient claustrophobia, for performing interventional procedures monitored by magnetic resonance imaging where access to the imaging subject is enhanced by the short bore, for imaging children and other small subjects, and the like.

As the magnet geometry deviates from a long-bore configuration, designing the magnet coils to generate a uniform spherical field of view over which the magnetic field is substantially constant becomes more challenging. For magnet coils in which the length-to-diameter ratio is less than or about unity, it is difficult or impossible to design the magnet to produce a large, substantially spherical volume. It is particularly difficult to simultaneously eliminate the sixth and eighth order magnetic field harmonics in short bore magnets. These harmonics contribute significantly to producing a non-spherical field of view.

A spherical volume is conventional, and enables the imaging apparatus to be used for a wide range of imaging applications. For example, shortening of the field of view along a direction transverse to the magnet bore axis restricts the radial field of view of axial slices, while shortening of the field of view along the magnet bore axis restricts the longitudinal extent of the imaging volume limiting a number of transverse slices, restricting skewed imaging planes, limiting a length of sagittal imaging planes, and the like.

Although the problem of obtaining a large, generally spherical field of view is particularly acute for short bore magnets, even in longer bore magnets obtaining a large, generally spherical field of view can be challenging. This is especially true for interventional magnetic resonance imaging scanners that have a large bore diameter, and for magnets with side access openings.

The present invention contemplates an improved apparatus and method that overcomes the aforementioned limitations and others.

According to one aspect, a magnetic resonance imaging apparatus is disclosed, including a first magnetic field coil and a second magnetic field coil. A power supply energizes the first magnetic field coil and selectively energizes the second magnetic field coil to selectively generate a first magnetic field defining a first selectable field of view that is elongated in a first direction and a second magnetic field defining a second selectable field of view that is elongated in a second direction different from the first direction.

According to another aspect, a method is provided for producing a selectable field of view for magnetic resonance imaging. At least a first magnetic field coil is energized to generate a first magnetic field defining a first generally ellipsoidal field of view having a first cross-sectional dimension transverse to a magnet bore axis and a first length along the magnet bore axis. The first magnetic field coil and a second magnetic field coil are energized to generate a selectable second magnetic field defining a second generally ellipsoidal field of view having a second cross-sectional dimension transverse to the magnet bore axis and a second length along the magnet bore axis. A ratio between the first cross-sectional dimension and the first length is different from a ratio between the second cross-sectional dimension and the second length.

One advantage resides in providing a field of view having an elongation corresponding to a long dimension of the desired image region.

Another advantage resides in providing a magnetic resonance imaging scanner having a field of view that is elongated in a selected direction.

Yet another advantage resides in using magnetic field harmonics that are difficult to remove by magnet design to provide a selectable field of view.

Numerous additional advantages and benefits will become apparent to those of ordinary skill in the art upon reading the following detailed description of the preferred embodiments.

The invention may take form in various components and arrangements of components, and in various process operations and arrangements of process operations. The drawings are only for the purpose of illustrating preferred embodiments and are not to be construed as limiting the invention.

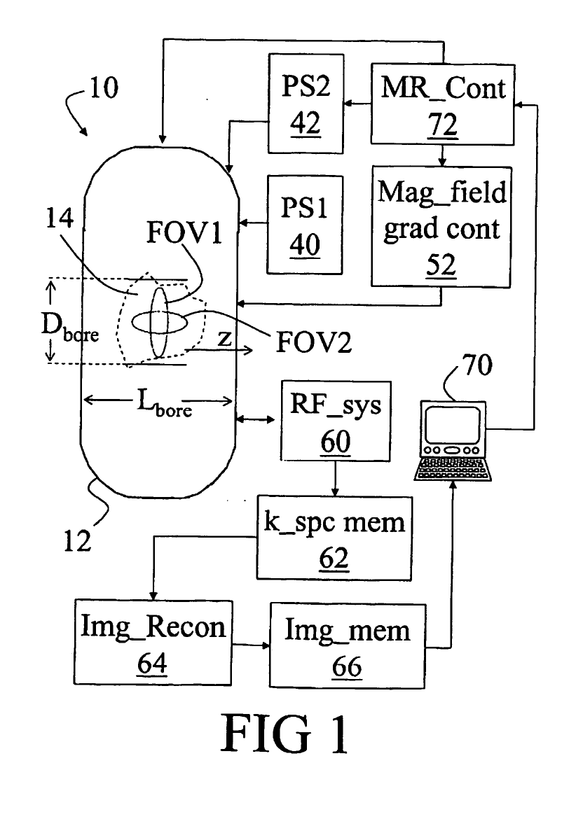

FIG. 1 shows a diagrammatic representation of a magnetic resonance imaging system including a magnetic resonance imaging scanner having a selectable field of view. The magnetic resonance imaging scanner has a portion of the housing cut away to reveal the magnet bore.

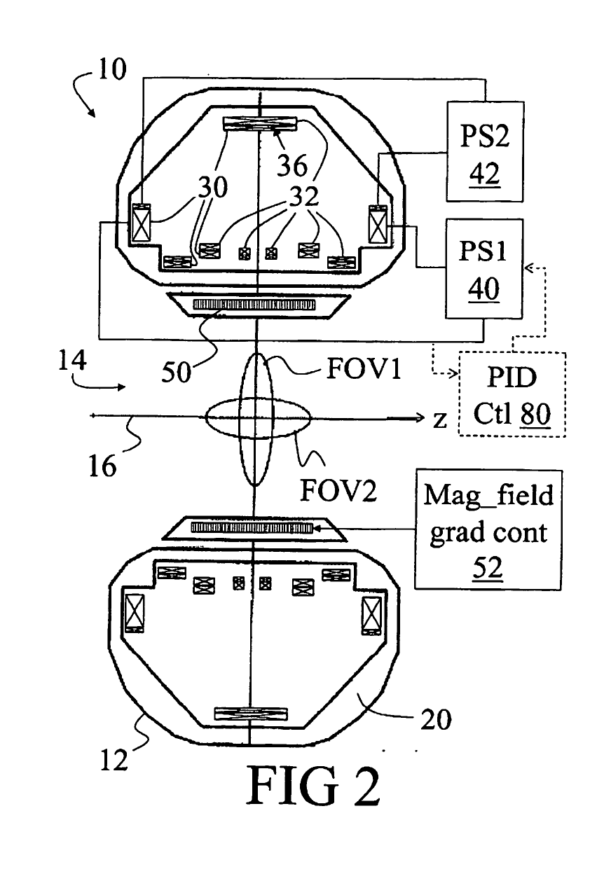

FIG. 2 shows a vertical sectional slice of the magnetic resonance imaging scanner of FIG. 1.

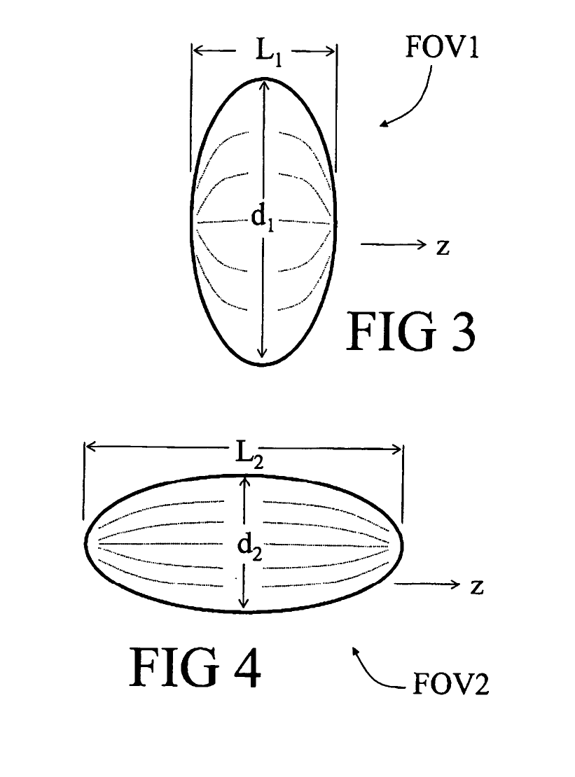

FIG. 3 shows a perspective spatial representation of the first field of view.

FIG. 4 shows a perspective spatial representation of the second field of view.

With reference to FIGS. 1-4, a magnetic resonance imaging system includes a magnetic resonance imaging scanner 10 having a generally cylindrical housing 12 defining a magnet bore 14 and a magnet bore axis 16. The magnet bore axis 16 is also designated as the z-axis. Although a toroidal magnet housing 12 is illustrated, an open magnet can be employed instead. In some embodiments, the magnetic resonance imaging scanner 10 includes a short-bore magnet in which a bore length L_{bore} is less than or equal to a bore diameter, D_{bore}, and, in one embodiment, is less than one meter. However, longer bore magnets such as magnets in which L_{bore} is greater than one meter can also be used.

With particular reference to FIG. 2, the generally toroidal housing 12 defines a cryoshroud volume 20 for cryoshrouding first and second superconducting magnetic field coils 30, 32. Resistive coils can also be used. The first and second magnetic field coils 30, 32 are arranged adjacent to one another in coil packages. Each coil package includes a winding of the first magnetic field coil and a winding of the second magnetic field coil. The windings of the first magnetic field coil are electrically connected in series or in another electrical configuration to define the first magnetic field coil 30, while the windings of the second magnetic field coil are electrically connected to define the second magnetic field coil 32. In the embodiment illustrated in FIG. 2, within each coil package the portions of the first magnetic field are arranged relatively closer to the magnet bore 14, while the portions of the second magnetic field are arranged relatively further away from the magnet bore 14. This relative positioning is reversed for a stray field-compensating or shield coil package 36 that is arranged further away from the magnet bore 14 than the other coil packages. In some embodiments, a length-to-diameter ratio of the magnetic field coils 30, 32 is less than unity.

The first magnetic field coil 30 is energized by a first power supply 40 to generate a first magnetic field defining a first selectable field of view FOV1, which is elongated in a direction transverse to the magnet bore axis 16. Significant sixth and eighth order magnetic field harmonics inherent in the first coil windings significantly contribute to the elongation of the first field of view FOV1. Depending upon a relative sign of the sixth and eighth order magnetic field harmonics, the field of view is elongated longitudinally or radially. In one relative sign case, the field of view FOV1 is elongated radially symmetrically similarly to a sphere that has been flattened toward a transverse disk. With the other relative sign of the sixth and eighth order harmonics, the field of view FOV2 is elongated in the direction generally parallel to the magnet bore axis 16. Those skilled in the art appreciate that it is difficult to eliminate the field of view elongation effect of the sixth and eighth order harmonics, especially for short-bore magnets and for magnets having a length-to-diameter ratio of less than unity. The first magnetic field coil 30 produces a Bₒ magnetic field component along the magnet bore axis 16 which serves as the main magnetic field for imaging along with sixth and eighth order harmonics which shape the uniform field of view as FOV1 or FOV2, depending upon the sign of the sixth and eighth order harmonics.

The second magnetic field coil 32 is selectively energized by a second power supply 42 to generate a supplementary magnetic field which combines with the first magnetic field produced by energizing the first magnetic field coil 30 to reverse the relative sign of the sixth and eighth order harmonics defining a second selectable field of view as the other of FOV1 and FOV2. In one embodiment, the second magnetic field coil 32 produces substantially no Bₒ magnetic field component parallel to the magnet bore axis 16. As a result, energizing the second magnetic field coil 32 to switch between the first field of view FOV1 and the second field of view FOV2 does not change the proton magnetic resonance frequency.

In an alternative embodiment, the first and second magnetic field coils 30, 32 are designed such that the uniform field shape changes between first and second fields of view by reversing the direction of the current in the second magnetic field coil at substantially constant amplitude. In this embodiment, the first field of view is defined by energizing the first magnetic field coil 30 and by energizing the second magnetic field coil 32 at a first current. The second field of view is defined by continuing to energize the first magnetic field coil 30 and by changing the energizing of the second magnetic field coil 32 to a second current different from the first current. This approach can reduce transient switching energy losses. Typically, the first and second currents of the second magnetic field coil 32 have opposite current flow directions.

With particular reference to FIG. 3, the first field of view FOV1 has a generally ellipsoidal shape, with a circular cross-section of diameter d₁ generally transverse to the direction of the magnet bore axis 16, and a length L₁ along the direction of the magnet bore axis 16. In FIG. 3, the generally ellipsoidal first field of view FOV1 has an oblate ellipsoidal shape in which the diameter d₁ is greater than the length L₁. In one embodiment for a short-bore magnet with length L_{bore} approximately 800 mm and diameter d_{bore} approximately 800 mm, the first field of view FOV1 has a diameter d₁=400 mm and a length L₁=80 mm.

With particular reference to FIG. 4, the second field of view FOV2 also has a generally ellipsoidal shape, with a circular cross-section of diameter d₂ generally transverse to the direction of the magnet bore axis 16, and a length L₂ along the direction of the magnet bore axis 16. In FIG. 4, the generally ellipsoidal second field of view FOV2 has a prolate ellipsoidal shape in which the diameter d₂ is smaller than the length L₂. In the short-bore magnet embodiment, the second field of view FOV2 has a diameter d₂=100 mm and a length L₂=300 mm.

The illustrated configuration of the first and second magnetic field coils 30, 32 and of the corresponding first and second fields of view FOV1, FOV2 is exemplary only. Those skilled in the art can readily modify the illustrated configuration for specific applications. For example, the relative positioning of the coil portions in the coil packages can be reversed, so that the second coil that produces the supplementary magnetic field is arranged relatively closer to the magnet bore 14. Moreover, the coils can be designed so that the first magnetic field coil produces a first field of view having a prolate ellipsoidal shape, while addition of the supplementary magnetic field produced by the second magnetic field coil produces a field of view having an oblate ellipsoidal shape. It is also contemplated for one of the first and second fields of view to be generally spherical; that is, to have an ellipsoidal shape in which the length along the direction of the magnet bore axis 16 substantially equals the circular cross-section diameter. Still further, it is contemplated for the circular cross-section to be replaced by an elliptical or otherwise-shaped cross-section. For example, in a scanner having an elliptical bore cross-section it may be advantageous to have ellipsoidal fields of view with elliptical, rather than circular, cross-sections.

Optionally, the second power supply 42 is a variable power supply that supplies an adjustable amount of power to the second coil 32. This permits the supplementary magnetic field to be adjusted so that the combination of the first magnetic field and the adjusted supplementary magnetic field produces an adjusted second field of view having a spatial extent intermediate between the first field of view FOV1 and the second field of view FOV2. It is also contemplated to employ more than one magnetic field coil to generate the supplementary magnetic field. In this arrangement, the second field of view can be adjusted by selectively energizing the plurality of supplementary magnetic field coils.

With particular reference to FIG. 2, the magnetic resonance imaging scanner 10 further includes a set of magnetic field gradient coils 50 for producing magnetic field gradients inside the magnet bore 14. In a preferred embodiment, one or more variable field of view magnetic field gradient coils 50 are selectively energized by a magnetic field gradient controller 52 to produce one or more substantially linear magnetic field gradients within a volume selected to generally coincide with the selected one of the first field of view FOV1 and the second field of view FOV2. Variable field of view magnetic field gradient coils, as disclosed, for example, in U.S. Pat. No. 6,479,999 issued to DeMeester et al., are suitable. Preferably, a plurality of magnetic field gradient coils 50 are provided, for example, separate coils for producing magnetic field gradients in the x-, y-, and z-directions.

With particular reference to FIG. 1, the magnetic resonance imaging system further includes a radio frequency system 60 including components well-known in the art and therefore not illustrated in detail herein. Typically, the radio frequency system 60 includes a whole-body radio frequency coil, local radio frequency coil, radio frequency coil array, or the like disposed inside the magnet bore 14 or inside the magnet housing 12, a radio frequency transmitter coupled to one or more said radio frequency coils or coil arrays for exciting a magnetic resonance in an imaging subject, and a radio frequency receiver coupled to one or more said radio frequency coils or coil arrays for receiving magnetic resonance signals from the imaging subject.

Such magnetic resonance signals are preferably spatially encoded as k-space samples by magnetic field gradients produced by the magnetic field gradient coils 50, for example by applying a slice-selective magnetic field gradient during magnetic resonance excitation followed by application of phase-encoding gradients, and readout gradients applied during sampling of the magnetic resonance signals. This spatial encoding scheme is exemplary only; substantially any type of spatial encoding scheme can be employed to spatially encode the selected one of the first field of view FOV1 and the second field of view FOV2. Magnetic resonance signal k-space samples are suitably stored in a k-space memory 62. An image reconstruction processor 64 applies an inverse Fourier transform or other reconstruction algorithm to generate one or more reconstructed images from the k-space data.

The reconstructed images are stored in an images memory 66, and are processed and displayed on a user interface 70, stored in a non-volatile memory, communicated over a local area network or the Internet, or otherwise utilized. The user interface 70 preferably includes a display, printer, or other output device that allows a technician, radiologist or other operator or diagnostician to view, render, or otherwise manipulate the reconstructed images. Moreover, the user interface 70 preferably enables the operator to communicate with a magnetic resonance imaging sequence controller 72 to select magnetic resonance imaging sequences, modify imaging sequences, execute imaging sequences, or otherwise control the magnetic resonance imaging scanner 10.

In order to switch from the first field of view FOV1 to the second field of view FOV2, the magnetic resonance imaging controller 72 operates the second power supply 42 to energize the second coil 32. Typically, it takes less time for the second coil to be stabilized in the energized state than to prepare a patient for imaging, for example about five to ten minutes. Similarly, during switching from the second field of view FOV2 to the first field of view FOV1, the second power supply 42 deenergizes the second coil 32. In one embodiment, the first magnetic field coil 30 and the second magnetic field coil 32 are relatively arranged such that there is substantially no mutual inductance therebetween. In this case, the energizing or deenergizing of the second magnetic field coil 32 does not affect the first magnetic field coil 30, which remains energized at a constant level during imaging and during switching between fields of view FOV1, FOV2.

With particular reference to FIG. 2, if there is some mutual inductive coupling between the first magnetic field coil 30 and the second magnetic field coil 32, then a feedback controller 80 can be implemented that controls the first power supply 40 to maintain a constant energizing through the first magnetic field coil 30 during switching between fields of view FOV1, FOV2. (Feedback controller 80 and associated feedback and control signal paths are shown in phantom in FIG. 2). In one embodiment, a current controller employing proportional-integral-derivative (PID) control monitors electrical current flowing through the first magnetic field coil 30 and controls the first power supply 40 to maintain a constant electrical current flowing through the first magnetic field coil 30.

The first magnetic field coil 30 can be energized to produce a constant magnetic field regardless of whether the first field of view FOV1 or the second field of view FOV2 is selected. As a result, the transient response characteristics of the first magnetic field coil 30 is generally not significant. However, the transient response characteristics of the second magnetic field coil 32 which is energized and deenergized during switching between the fields of view FOV1, FOV2 is preferably rapid. Rapid transient coil response is suitably achieved by designing the second magnetic field coil 32 with the goal of reducing ramping losses, for example by using conductors with low hysteresis losses and by minimizing induced eddy-currents in cryostat or coil support components. Transient energy losses during switching of the second magnetic field coil 32 cause helium boil-off during current changes in the coil 32, and should be reduced by conductor selection, usage of low-conductivity coil support structures, and the like. Optionally, superconducting or resistive shim coils (not shown) are included to shim one or both of the first and second magnetic fields.

Selection between fields of view FOV1, FOV2 is typically made based on the type of imaging to be performed. For example, during spinal imaging of a prone human subject, the spine is aligned with the magnet bore axis 16, and so the second field of view FOV2 which is elongated along the magnet bore axis 16 typically provides better spinal coverage than the first field of view FOV1. On the other hand, for axial slices that are orthogonal to the magnet bore axis 16, or for volumetric imaging using a plurality of adjacent axial slices, the first field of view FOV1 which is radially elongated transverse to the magnet bore axis 16 is preferably used. In a preferred embodiment, the magnetic resonance imaging controller 72 selectively operates the second power supply 42 to select between the first field of view FOV1 obtained by deenergizing the second coil 32 and the second field of view FOV2 obtained by energizing the second coil 32.

The invention has been described with reference to the preferred embodiments. Obviously, modifications and alterations will occur to others upon reading and understanding the preceding detailed description. It is intended that the invention be construed as including all such modifications and alterations insofar as they come within the scope of the appended claims or the equivalents thereof.

1. A magnetic resonance imaging apparatus including:
a first magnetic field coil;
a second magnetic field coil; and
a power supply that energizes the first magnetic field coil selectively energizes the second magnetic field coil to selectively generate a first magnetic field defining a first selectable field of view that is elongated in a first direction and a second magnetic field defining a second selectable field of view that is elongated in a second direction different from the first direction.

2. The magnetic resonance imaging apparatus as set forth in claim 1, further including:
a magnet housing inside of which the first magnetic field coil and the second magnetic field coil are disposed, thee magnet housing defining a magnet bore and a magnet bore axis, the first and second selectable fields of view being disposed inside the magnet bore.

3. The magnetic resonance imaging apparatus as set forth in claim 2, wherein:
one of the first direction and the second direction is parallel to the magnet bore axis; and
the other of the first direction and the second direction includes a radially symmetric direction generally transverse to the magnet bore axis.

4. The magnetic resonance imaging apparatus as set forth in claim 2, wherein:
the first magnetic field is produced by energizing the first magnetic field coil without energizing the second magnetic field coil; and
the second magnetic field is produced by combining the first magnetic field with a supplementary magnetic field produced by energizing the second magnetic field coil.

5. The magnetic resonance imaging apparatus as set forth in claim 4, wherein:
the first magnetic field includes a magnetic field component parallel to the magnet bore axis; and
the supplementary magnetic field produces substantially no magnetic field component parallel to the magnet bore axis.

6. The magnetic resonance imaging apparatus as set forth in claim 2, wherein:
the first magnetic field is produced by energizing the first magnetic field coil and by energizing the second magnetic field coil at a first non-zero current; and
the second magnetic field is produced by energizing the first magnetic field coil and by energizing the second magnetic field coil at a second non-zero current having an opposite current flow direction from the first non-zero current.

7. The magnetic resonance imaging apparatus as set forth in claim 2, wherein the magnet bore is less than one meter long.

8. The magnetic resonance imaging apparatus as set forth in claim 2, wherein:
the first field of view is an ellipsoidal field of view having at least one generally circular cross-section transverse to the magnet bore axis; and
the second field of view is an ellipsoidal field of view having at least one generally circular cross-section transverse to the magnet bore axis.

9. The magnetic resonance imaging apparatus as set forth in claim 8, wherein:
one of the first field of view and the second field of view is a prolate ellipsoidal field of view and the other of the first field of view and the second field of view is an oblate ellipsoidal field of view.

10. The magnetic resonance imaging apparatus as set forth in claim 1, wherein:
the first magnetic field includes a sixth order harmonic and an eighth order harmonic, the sixth and eighth order harmonics having first relative polarities or signs; and
the second magnetic field includes a sixth order harmonic and an eighth order harmonic, the second magnetic field sixth and eighth order harmonics having opposite polarities or signs relative to the first magnetic field sixth and eighth order harmonics.

11. The magnetic resonance imaging apparatus as set forth in claim 1, wherein:
the first magnetic field coil and the second magnetic field coil are arranged as a plurality of coil packages, each coil package including a portion of the first magnetic field coil and a portion of the second magnetic field coil, the portions of the first magnetic field coil being electrically connected in series to electrically define the first magnetic field coil, and the portions of the second magnetic field coil being electrically connected in series to electrically define the second magnetic field coil.

12. The magnetic resonance imaging apparatus as set forth in claim 1, wherein the first magnetic field coil and the second magnetic field coil are relatively arranged such that there is substantially no mutual inductance therebetween.

13. The magnetic resonance imaging apparatus as set forth in claim 1, further including:
a feedback controller controlling the power supply to maintain a constant energizing of the first magnetic field coil during switching between the first field of view and the second field of view.

14. The magnetic resonance imaging apparatus as set forth in claim 1, wherein the magnet bore has a length which is equal to or shorter than a bore diameter.

15. The magnetic resonance imaging apparatus as set forth in claim 1, further including:
a variable field of view magnetic field gradient coil that produces a substantially linear magnetic field gradient within a volume selected to generally coincide with the selected one of the first field of view and the second field of view.

16. A method for producing a selectable field of view for magnetic resonance imaging, the method including:
energizing at least a first magnetic field coil to generate a first magnetic field defining a first generally ellipsoidal field of view having a first cross-sectional dimension transverse to a magnet bore axis and a first length along the magnet bore axis; and
energizing the first magnetic field coil and a second magnetic field coil to generate a selectable second magnetic field defining a second generally ellipsoidal field of view having a second cross-sectional dimension transverse to the magnet bore axis and a second length along the magnet bore axis, a ratio between the first cross-sectional dimension and the first length being different from a ratio between the second cross-sectional dimension and the second length.

17. The method as set forth in claim 16, further including:
varying the selective energizing of the second magnetic field coil to adjust between the first and second magnetic fields, the adjusted magnetic field defining an adjusted field of view having a spatial extent intermediate between the first field of view and the second field of view.

18. The method as set forth in claim 16, wherein the selective energizing of the second magnetic field coil includes:
energizing the second magnetic field coil at a first non-zero current to produce the first magnetic field defining the first generally ellipsoidal field of view; and
energizing the second magnetic field coil at a second non-zero current different from the first non-zero current to produce the second magnetic field defining the second generally ellipsoidal field of view.

19. The method as set forth in claim 16, wherein:
one of the first generally ellipsoidal field of view and the second generally ellipsoidal field of view is a prolate ellipsoidal field of view and the other of the first generally ellipsoidal field of view and the second generally ellipsoidal field of view is an oblate ellipsoidal field of view.

20. The method as set forth in claim 16, wherein:
the first and second cross-sectional dimensions are radii of circular cross-sections of the generally ellipsoidal fields of view transverse to the magnet bore axis.
